(19) United States
(12) Patent Application Publication
(10) Pub. No.: US 2007/0115371 A1
(43) Pub. Date: May 24, 2007

(54) Image processing method, image processing program, and image processing apparatus

(75) Inventors: Jun Enomoto, Kanagawa (JP); Takafumi Matsushita, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/603,862

(22) Filed: Nov. 24, 2006

(30) Foreign Application Priority Data
Nov. 24, 2005 (JP) 2005-338813

(51) Int. Cl. H04N 5/228

(52) U.S. Cl. 348/222.1

(57) ABSTRACT

The image processing method and apparatus perform image processing on acquired image data. The method and apparatus detect a face from an image represented by the acquired image data and/or executing scene identification of the image, modify processing conditions for special processing to be performed in accordance with results of face detection and/or the scene identification, perform automatically predetermined common image processing on the image data and perform the special processing on the image data based on the modified processing conditions for the special processing. The special processing is different from the predetermined common image processing and image processing to be executed in accordance with designation from an external. The image processing program executes the above image processing method on a computer.

### BACKGROUND OF THE INVENTION

The present invention generally relates to an image processing method, an image processing program and an image processing apparatus, and more particularly to an image processing method for performing different image processing on each image in accordance with results of face detection in an image and/or scene identification of the image, an image processing program executing the same on a computer and an image processing apparatus implementing the image processing method.

In recent years, production of photographic prints may include special types of image processing (hereinafter, referred to simply as “special image processing or special processing”) that are performed based on the requirements of customers in addition to standard types of image processing (hereinafter, referred to simply as “common image processing”) such as correction or adjustment of color and/or density of an image. Examples of such special image processing are soft focusing processing providing soft focusing effect; cross filtering processing providing a cross filter effect imparting cross light, sparkle, star-like flare or the like (hereinafter, referred to as “cross light”) on the image by using a digital cross filter; and image composite or synthesis whereby animated or cartoon characters, a photo frame and/or written characters (letters, numerals, symbols, etc.) are superimposed over an image.

In these special image processing that has been conventionally performed, the same processing is executed uniformly over the whole area of an image designated by a customer, irrespective of the contents of the image.

Accordingly, when cross filtering processing is performed on an image that contains a person, for example, cross light (cross filter effect) may be superimposed on teeth and/or eyes of the person as well, or tailing of the cross light over the background may extend over the face of the person.

Further, some types of special processing may not produce any favorable effects depending on the contents of an image. For example, soft focus processing, when applied to an image that contains a person, may produce desirable effects, making person's face appear beautiful, but may not produce sufficient effects when applied, for example, to an image of a landscape without persons.

Thus, conventional image processing techniques have had drawbacks in that a processed image conveyed unusual feelings because wholesale, sweeping processing is applied over the whole area of an image though the image may contain some areas where such processing should preferably not be applied, or image processing is applied even to an image for which no favorable effects may be expected from the processing.

Thus, various image processing methods have been proposed to solve the above problems. JP 2003-58880 A, for example, describes a cross filtering method capable of maintaining natural appearances of an image. According to this method, an operator sets a number of cross light to be provided to an area designated by the operator, their sizes, and the lengths of their streamers. This method provides some measure of solution to some of the problems other conventional techniques suffered, examples of which are that all the cross light in an image had substantially a same size; an image was given too many cross light; and a whole image looked excessively bright. Thus, unlike general, blanket type of processing, the method therein described provides some measure of natural cross filtering processing that do not convey unusual feelings.

JP 10-200671 A describes an image processing apparatus and an image reproducing system for performing finishing processing according to customers' preferences. An embodiment therein described provides image processing in which two or more pieces of finishing information are available that indicate different image processing characteristics for images having different contents and finishing information is selected according to the contents of the image to perform somewhat fine-tuned processing according to the contents of the image.

### SUMMARY OF THE INVENTION

Although JP 2003-58880 A describes a cross filtering method, the document fails to disclose any method for other types of special image processing. Further, the operator must have a considerable work because a target area of processing, sizes of the cross light and lengths of their streamers to be provided are determined as he/she enters such information.

In the image processing apparatus and the image reproducing system described in JP 10-200671 A, while there may be cases where finishing information can be automatically designated from shooting information such as use of flash and a brightness value as in an image containing a night view scene, it is most often the case that a customer must take the trouble of designating finishing information by operating a camera after pictures are taken or by designating finishing information at a photo lab, and only after that is the image processing performed as designated by the customer.

Thus, it is an object of the present invention to solve the above shortcomings the conventional techniques have suffered and to provide an image processing method for producing enhanced effects of image processing by performing image-specific processing that is achieved such that a face or faces are detected in a still image or one-frame image from a motion picture, face region information is produced from the face or faces detected, and a method of special processing is changed automatically to perform different processing for different areas of the image.

Another object of the present invention is to provide an image processing program executing the image processing method described above on a computer.

Still another object of the present invention is to provide an image processing apparatus for implementing the image processing method described above.

In order to attain the object described above, the present invention provides an image processing apparatus for performing image processing on acquired image data, comprising: face detecting means for detecting a face from an image represented by the acquired image data; common processing means for automatically performing predetermined common image processing on the image data; and special processing means for performing special processing on the image data based on processing conditions for the special processing, the special processing being different from the predetermined common image processing and being image processing to be executed in accordance with designation from an external; wherein the face detecting means supplies a result of face detection obtained by the face detecting means to the special processing means, and the special processing means modifies the processing conditions for the special processing to be performed in accordance with the result of the face detection supplied by the face detecting means.

In the image processing apparatus of the present invention, the face detecting means preferably supplies to the special processing means as the result of the face detection, information that indicates at least one of distinction between presence and absence of the face, a position of the face and a size of the face.

Preferably, the face detecting means supplies to the special processing means as the result of the face detection, the information that indicates at least the distinction between presence and absence of the face and the size of the face, and, when the special processing means performs soft focusing processing for providing a soft focus effect as the special processing, the special processing means modifies an intensity of the soft focusing processing in accordance with the supplied information that indicates the distinction between presence and absence of the face and the size of the face.

Preferably, the face detecting means supplies to the special processing means as the result of the face detection, the information that indicates at least the distinction between presence and absence of the face and the position of the face, and, when the special processing means performs cross filtering processing for providing a cross filter effect as the special processing, the special processing means sets conditions for cross filtering processing in accordance with the supplied information that indicates at least the distinction between presence and absence of the face and the position of the face such that cross light obtained by the cross filtering processing and a face region of the face do not overlap each other.

Preferably, the face detecting means supplies to the special processing means as the result of the face detection, the information that indicates at least the distinction between presence and absence of the Lace and the position of the face, and, when the special processing means performs image composition processing as the special processing, the special processing means sets conditions for the image composition in accordance with the supplied information that indicates at least the distinction between presence and absence of the face and the position of the face such that an image to be superimposed and a face region of the face do not overlap each other.

Preferably, the face detecting means supplies to the special processing means as the result of the face detection, the information that indicates at least the distinction between presence and absence of the face and the position of the face, and, when the special processing means performs lighting processing for providing a lighting effect as the special processing, the special processing means modifies an intensity of the lighting processing in a face region of the face in accordance with the supplied information that indicates the distinction between presence and absence of the face and the position of the face.

Preferably, the image processing apparatus of the present invention further comprises: scene identifying means for executing scene identification of the image and supplying a result of the scene identification to the special processing means, and the special processing means modifies the processing conditions for the special processing to be performed in accordance with the result of the scene identification supplied by the scene identifying means in addition to the result of the face detection supplied by the face detecting means.

The present invention also provides an image processing apparatus for performing image processing on acquired image data, comprising: scene identifying means for executing scene identification of an image represented by the acquired image data; common processing means for automatically performing predetermined common image processing on the image data; and special processing means for performing special processing on the image data based on processing conditions for the special processing, the special processing being different from the predetermined common image processing and being image processing to be executed in accordance with designation from an external; wherein the scene identifying means supplies a result of the scene identification obtained by the scene identifying means to the special processing means, and the special processing means modifies the processing conditions for the special processing to be performed in accordance with the result of the scene identification supplied by the scene identifying means.

In the image processing apparatus of the present invention, when the special processing means performs cross filtering processing for providing a cross filter effect as the special processing, the special processing means preferably modifies at least one of an intensity of the cross filtering processing, a shape of cross light obtained by the cross filtering processing and a color of the cross light in accordance with the result of the scene identification.

When the special processing means performs lighting processing for providing a lighting effect as the special processing, the special processing means preferably modifies an intensity of the lighting processing in accordance with the result of the scene identification.

Preferably, the image processing apparatus of the present invention further comprises: face detecting means for detecting a face from the image represented by the image data and supplying a result of face detection to the special processing means, and the special processing means modifies the processing conditions for the special processing to be performed in accordance with the result of the face detection supplied by the face detecting means in addition to the result of the scene identification supplied by the scene identifying means.

In order to attain the object described above, the present invention further provides an image processing method for performing image processing on acquired image data, comprising the steps of: detecting a face from an image represented by the acquired image data and/or executing scene identification of the image; modifying processing conditions for special processing to be performed in accordance with results of face detection and/or the scene identification; automatically performing predetermined common image processing on the image data; and performing the special processing on the image data based on the modified processing conditions for the special processing, wherein the special processing is different from the predetermined common image processing and image processing to be executed in accordance with designation from an external.

The present invention still further provides an image processing program to execute on a computer an image processing method for performing image processing on acquired image data, the image processing method, comprising the steps of: detecting a face from an image represented by the acquired image data and/or executing scene identification of the image; modifying processing conditions for special processing to be performed in accordance with results of face detection and/or the scene identification; automatically performing predetermined common image processing on the image data; and performing the special processing on the image data based on the modified processing conditions for the special processing, wherein the special processing is different from the predetermined common image processing and image processing to be executed in accordance with designation from an external.

Thus, the present invention is capable of performing a different special processing step on each area of a still image or one-frame image from a motion picture by determining the presence/absence of a face or faces in the image through face detection and automatically determining, for example, target areas and intensities of various special processing steps based on the results of the face detection. Thus, unlike conventional methods with which a general, sweeping type of special processing was applied to the whole area of an image, the method of the present invention allows special processing to be performed on the area to which it is to be applied, and, as a result, the possibility of performing a type of processing to a particular area of an image to which that processing should preferably not be applied can be eliminated, yielding an image with natural appearances that do not convey strange feelings, and burdens on customers and an operator are also avoided.

In addition to face detection whereby an area of a face region is determined, an image analysis may be performed to execute scene identification of an image from among scenes such as an evening view scene, a night view scene, and an undersea scene, to achieve special processing for each image according to the results of the face detection and the scene identification. Thus obtained is an image provided with more enhanced effects of special processing.

### BRIEF DESCRIPTION OF THE DRAWINGS

FIG. 1 is a block diagram of a first embodiment of an image forming apparatus that includes an image processing apparatus according to the present invention.

FIG. 2 is a flow chart illustrating a first embodiment of an image processing method according to the present invention.

FIG. 3 is a flow chart illustrating a second embodiment of the image processing method according to the present invention.

### DETAILED DESCRIPTION OF THE INVENTION

An image processing method, an image processing program and an image processing apparatus of the present invention will now be described in detail referring to the preferred embodiments illustrated in the attached drawings.

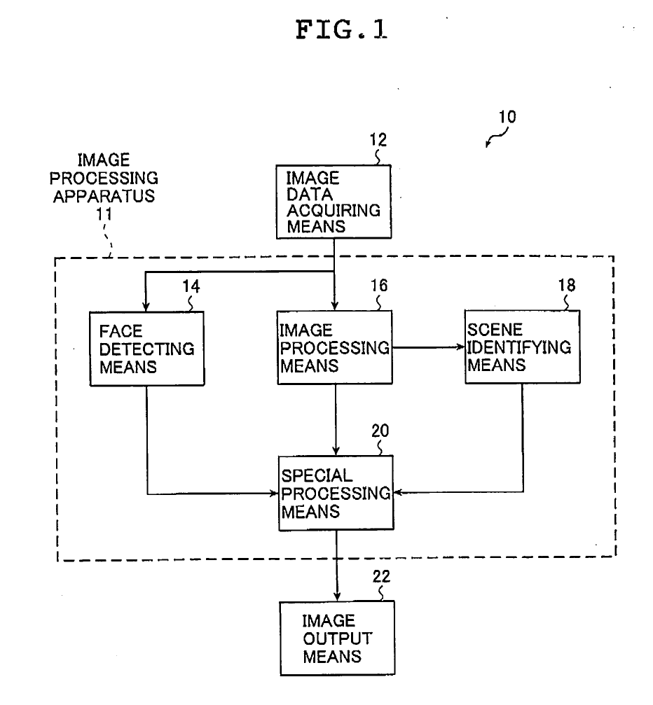

FIG. 1 is a schematic block diagram showing an embodiment of an image forming apparatus that includes an image processing apparatus to implement an image processing method or execute an image processing program according to the present invention.

As illustrated in FIG. 1, an image forming apparatus 10 comprises image data acquiring means 12, face detecting means 14, image processing means 16, scene identifying means 18, special processing means 20, and image output means 22. An image processing apparatus 11 comprises the face detecting means 14, the image processing means 16, the scene identifying means 18, and the special processing means 20. The image processing apparatus 11 may be configured by using, for example, a computer or a work station.

The image data acquiring means 12 acquires image data and supplies the acquired image data to the face detecting means 14 and the image processing means 16.

The image data acquiring means 12 may acquire image data by, for example, reading an image from a storage medium installed in a drive of the image data acquiring means 12. The storage medium compatible with the drive is not limited in any particular way, and any known storage media may be used as exemplified by Smart Media™, Compact Flash™, Memory Stick™, SD Memory Card™, a PC card, a CD-R, and an MD. The image data acquiring means 12 may support a single type, or two or more types of recording media. The image data acquiring means 12 may acquire images through a known network such as the Internet. The image data acquiring means 12 may alternatively be a scanner that photoelectrically reads an image on a transparent original such as a negative film or an image on a reflective original. The image data acquiring means 12 may also be of a type that acquires image data from, for example, a digital camera and/or a video camera. Alternatively, the image data acquiring means 12 may be adapted to acquire image data by more than one of these means.

The face detecting means 14 performs face detection from an image corresponding to the image data supplied from the image data acquiring means 12 and produces face region information based on results of the face detection.

The face region information, produced based on the results of the face detection from an image, may comprise such information as, for example, the position and the size of a face detected, and a face detection reliability. The face region information is used in the special processing means 20 to be described later to set processing conditions for performing special processing on image data. The face detecting means 14 executes face detection on the image data supplied from the image data acquiring means 12 and determines whether a face is present in an image corresponding to the image data. When the face detecting means 14 detects a face in the image, the face detecting means 14 works out face detection results including the position (e.g., coordinates or an area defined thereby) and the size of the face, and the face detection reliability to produce face region information from such results.

Face detection may be executed by any known method such as a template matching method, a method using skin color detection, a method using edge detection, a method based on contour recognition, or a method combining two or more of these methods. Still further methods as described in commonly assigned JP 2000-137788 A, JP 2000-149018 A, JP 9-138471 A, and JP 8-184925 A may also be preferably used for face detection.

The face detecting means 14 sends the produced face region information to the special processing means 20.

The image processing means 16 performs general image processing through analysis of the image data supplied from the image data acquiring means 12.

The image processing as used in the present invention refers to basic image correction processing performed to output an image with, for example, an appropriate image color/density (tone reproduction and color reproduction) and an appropriate image structure (sharpness and graininess). Such correction processing yields a finished image in terms of photographic picture quality, or, to be more specific, a finished image that corresponds to an image output such as a printout and that does not undergo special image processing to be described. Specifically, the image processing according to the present invention may include, for example, image enlargement or image contraction (electronic magnification), gradation correction, color/density correction, saturation correction, sharpness adjustment, and “dodging” (contraction or expansion of an image density dynamic range effected such that the image halftone is kept intact).

The image processing may also comprise a defect compensation that is applied only to those images that contain a defect or defects in order to correct an image defect. Such defect compensations may include, for example, a correction of red eye caused by a camera flash (red-eye correction), a compensation for defects in an image (pixels) due to foreign substances attached to a photographic film or a camera lens, or scratches on a photographic film or a camera lens (processing to erase dust- or scratch-caused spots), a correction of image distortion attributable to aberrations of a camera lens (lens aberration correction), and a compensation for a decreased marginal density resulting from the marginal luminosity deterioration characteristic of a camera lens (marginal luminosity deterioration correction).

Aside from the image processing described above, special processing executed by the special processing means 20 to be described is performed only on those images for which a customer requested the special processing, according to the requests and desires of the customer (a person who places an order for prints or image data). Specifically, the special processing includes, for example, soft focusing processing; cross filtering processing for adding crossed rays of light to bright spots in an image (i.e., processing for causing bright spots to shine in a cross shape); image composition processing that adds, for example, (animated) cartoon characters, a photo frame, and/or written characters to an image; and lighting processing that provides such effects as a spot light effect, an overall lighting effect, and a backlight effect by forming on an image a highlight spot that serves as an artificial light source and radially synthesizing light from the highlight spot while adjusting, for example, the light source/illumination, light attributes, and angles.

Special processing of these types may be accomplished using any known method.

The special processing is executed by the special processing means 20 as will be described in detail.

Image data processed by the image processing means 16 is sent as corrected image data to the scene identifying means 18 and the special processing means 20.

The scene identifying means 18 analyzes, from among the corrected image data supplied from the image processing means 16, such corrected image data as requires special processing, and identifies the scene of an image to be subjected to the special processing.

In the illustrated first embodiment, the scene identifying means 18 identifies the scene of an image of interest as an evening view scene; a night view scene; an undersea scene; a blue-sky scene; a high-saturation scene; a high-key scene as is seen in an image in which the white area accounts for a large percentage, a typical example thereof being a snow-covered landscape (e.g., an image containing a white area that accounts for 50% of the whole image); or another scene. The scene identifying means 18 sends results of scene identification to the special processing means 20.

The scene identification may be executed, for example, by using a proper characteristic quantity for identifying the respective scenes. Specifically, proper characteristic quantities may be previously defined for scene identification to verify the certainty factor of each of these proper characteristic quantities against an image. When a proper characteristic quantity has a certainty factor equal to or greater than a given certainty factor, the scene of the image of interest is identified as a scene having a proper characteristic quantity that has the highest certainty factor among all the scenes. Verification of certainties may be based, for example, on such conditions that an image contain an area in a proportion equal to or greater than a threshold or that an image contain a specific pattern.

The special processing means 20 performs special processing on, from among corrected image data supplied from the image processing means 16, such corrected image data as is designated for special processing. The type of special processing to be performed may be determined in advance by reading information from, for example, attributes information contained in image data or may be determined by an operator as he/she enters a type of special processing desired.

The special processing means 20 previously has two or more sets of processing conditions for special processing, according to which different processing methods and parameters are set. The special processing means 20 selects processing conditions for special processing for each of corrected image data according to face region information sent from the face detecting means 14 and, optionally, scene information sent from the scene identifying means 18, and performs necessary special processing based on the processing conditions selected.

The first embodiment of the present invention comprises, by way of example, 3 sets of processing conditions for special processing 1 to 3, respectively, i.e., a first condition that the area of a face region be equal to or larger than a threshold predefined in the image forming apparatus 10; a second condition that the area of a face region be smaller than the threshold; and a third condition that an image contain no face. When selecting processing conditions, the position of a face and/or a face detection reliability may also be taken into consideration in addition to the area of a face region and, furthermore, processing conditions may also be added for the respective scenes in consideration of scene information, as will be described later in detail.

Image data having undergone special processing in the special processing means 20 is sent as output image data to the image output means 22.

The image output means 22 outputs supplied output image data in a specified format. Specifically, any appropriate printer such as an ink jet printer or an electrophotographic printer may be used to output images. Alternatively, output image data may be outputted to a media storage means capable of writing data into storage media such as a CD-R to provide a customer with a storage medium that has output image data recorded thereon, or both prints and a storage medium containing output image data may be provided to the customer.

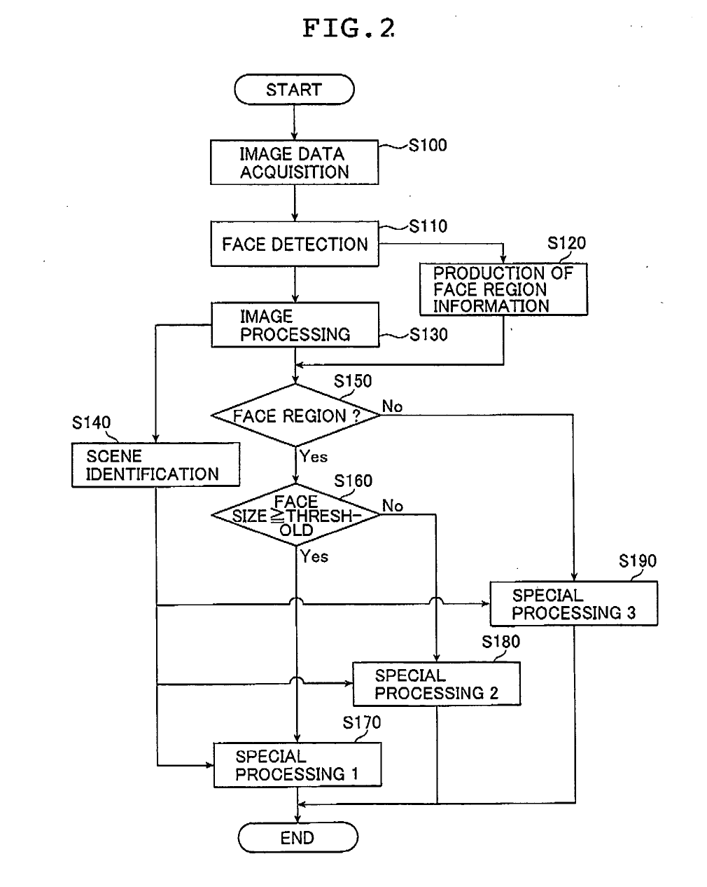

The operation of the image forming apparatus 10 comprising the image processing apparatus 11 according to the present invention will now be described in detail referring to the flow chart shown in FIG. 2.

On acquiring image data (S100), the image data acquiring means 12 sends the image data to the face detecting means 14 and the image processing means 16.

The face detecting means 14 only needs image data necessary for face detection and therefore the image data supplied to the face detecting means 14 may be pre-scan data (in cases where an image is acquired from, for example, a film scanner) or data obtained by thinning out image data.

The face detecting means 14 executes face detection on supplied image data (S110), produces face region information based on results of the face detection (S120), and sends the face region information to the special processing means 20.

In the meantime, the image processing means 16 performs image processing on supplied image data to produce corrected image data (S130). The image processing has already been described above. Then the image processing means 16 sends fully corrected image data to the special processing means 20 while sending corrected image data that requires special processing to the scene identifying means 18.

All that the image data supplied to the scene identifying means 18 needs to contain is image data necessary for scene identification and, therefore, the corrected image data to be supplied to the scene identifying means 18 may be thinned out.

The scene identifying means 18 analyzes corrected image data supplied, determines which of the above scenes the image corresponding to the image data represents, and produces scene information (S140). The scene identifying means 18 sends the scene information to the special processing means 20.

When all of the corrected image data, the face region information, and, where applicable, the scene information become available, the special processing means 20 determines whether corrected image data supplied requires special processing or not. Then the special processing means 20 determines whether corrected image data that requires special processing contains a face based on the face region information (S150). Corrected image data not requiring special processing is sent to the image output means 22 without performing any special processing. When image data requiring special processing contains a face, the special processing means 20 compares a predefined threshold of a face region with the area of the face region contained in the face region information, and determines whether the area of the face region in corrected image data is equal to or larger than the threshold, or smaller than the threshold (S160). Thus, corrected image data are sorted automatically into three categories so that special processing as required may be performed according to processing conditions which are different from category to category.

Where two or more face regions are detected within an image, such sorting process based on a threshold may be executed, for example, by comparing the threshold with the area of each of the face regions and, when the image data contains at least one face region that has an area equal to or larger than the threshold, that image data may be sorted into a category of image data containing a face region having an area equal to or larger than the threshold.

When comparing the area of a face region with the threshold to sort corrected image data according to face region information, the position of a face and the face detection reliability may also be taken into consideration. For example, in cases where the area of a face region of an image is smaller than a threshold but the face is located at or toward the center of the image or the face detection reliability is high, the area of that face region may be regarded as being equal to or larger than the threshold. Further, the number of faces and/or the sum of the areas of face regions may also be considered in the sorting process.

When a face region is detected in S150 and the area of the face region is found to be equal to or larger than the threshold in S160, the special processing means 20 performs special processing according to conditions for special processing 1 (S170).

The special processing 1 is performed on an image that contains a face region having an area equal to or larger than the threshold, and may be applied to images in which a major emphasis is placed on a person or persons, such as an image taken by a close-up shot of a person or an image in which a person's face is located at or toward the center.

In the special processing 1, soft focusing processing may be performed on the whole area of an image as in ordinary image processing. Alternatively, a face region may be singled out in the processing such that a face region of an image or its neighboring area, for example, may be processed to provide higher intensity than the other areas of the image to thereby produce more slightly enhanced effects than usual.

When cross filtering processing is performed, a face region of an image may be excluded from the target areas of the cross filtering processing, and the lengths of streamers may be adjusted such that the streamers and the face region do not overlap each other. In the image forming apparatus 10 comprising the image processing apparatus 11 of the present invention, the number of cross light, their sizes, and lengths of their streamers may be adjusted according to the proportion of the area of the face region to the area of the image such that, for example, when the area of a face region in an image is relatively large in proportion to the whole image, a relatively many cross light may be provided, number of the cross light may be relatively increased, and/or the cross light may have relatively long streamers. Conversely, when the area of a face region in an image is relatively small in proportion to the whole image, a relatively small number of cross light may be provided, the number of the cross light may be relatively decreased, and/or the cross light may have relatively short streamers.

When image composition processing is performed, if there are areas of overlap between a face region and, for example, (animated) cartoon characters, a photo frame, and/or written characters, their positions and/or sizes are automatically adjusted such that both do not overlap each other.

Lighting processing may be performed by excluding a face region of an image from the target areas of the lighting processing to avoid producing the lighting effect over the face region. Alternatively, lighting processing, when applied also to the face region, may be reduced as compared with the other areas of the image.

When a face region is detected in S150 and the area of the face region is found to be smaller than the threshold in S160, the special processing means 20 performs special processing according to conditions for special processing 2 (S180).

The special processing 2 is performed on an image that contains a face region having an area smaller than the threshold, i.e., an image in which the area of the face region is relatively small such as an image on a group photograph or an image containing a relatively small face region.

In the special processing 2, soft focusing processing is not performed on a face region or, alternatively, a face region is singled out in the processing such that, for example, the face region or its neighboring area may be processed to provide lower intensity than the other areas to thereby produce more slightly reduced effects than usual.

When cross filtering processing is performed, a face region of an image is excluded from the target areas of the cross filtering processing, and the lengths of streamers are adjusted such that the streamers and the face region do not overlap each other. In the special processing 2, the cross light may be larger than are provided in the special processing 1.

When image composition processing is performed, if there are areas of overlap between a face region and, for example, (animated) cartoon characters, a photo frame, and/or written characters, their positions and/or sizes are automatically adjusted such that both do not overlap each other.

Lighting processing may be performed by excluding a face region from the target areas of the lighting processing to avoid producing the lighting effect over the face region. Alternatively, the lighting processing, when applied also to the face region, may be reduced as compared with the other areas.

When no face region is detected in S150, the special processing means 20 performs special processing according to conditions for the special processing 3 (S190).

The special processing 3 is performed on an image containing no face, such as a scenery image.

In the special processing 3, soft focusing processing may be performed on a singled out landscape scene by, for example, reducing the intensity of the soft focusing processing. Alternatively, soft focusing processing may not be performed.

Cross filtering processing may be performed as usual. Alternatively, more cross light, larger cross light, and/or longer streamers may be provided to produce greater effects than in the special processing 1 and 2 described above.

As for image composition processing, ordinary processing is performed as specified and designated by customers.

Lighting processing may be performed as usual. Alternatively, an increased intensity of lighting processing may be provided when enhanced effects are desired.

Depending on the scene of an image, the special processing means 20 may include additional processing conditions to, or make modifications in, the three special processing conditions described above according to scene information supplied from the scene identifying means 18.

The processing conditions for scene identification in, for example, soft focusing processing may be modified according to the scene information (results of the scene identification), which are as follows: In an image having an evening view scene, different soft focusing effects may be provided to the image based on the evening view; in a night view scene, an increased intensity of soft focusing processing may be applied to an area representing a distant landscape whereas a reduced intensity of soft focusing processing may be applied to an area representing a nearby landscape; in an undersea or blue-sky scene, the intensity of the processing may be lowered to provide a reduced soft focusing effect; and in a high-saturation or high-key image, the intensity of the processing may be increased to provide an enhanced soft focusing effect, provided, however, that in the case of a high-saturation image, the intensity of the processing be adjusted with the saturation level maintained. These are examples of conditions that may be added to the processing conditions for special processing 1 to 3.

Cross filtering processing may be modified, for example, according to scene information (results of the scene identification) as follows: in an evening view scene, larger cross light with longer streamers may be provided in an evening view area, and/or the shapes of cross light may be varied; in a night view scene, more cross light may be provided and/or cross light with longer streamers may be provided to produce enhanced effects; in an undersea scene, fewer cross light may be provided and/or the shapes of cross light may be varied; in a blue-sky scene, cross filtering processing is not performed on areas representing the sky; in a high-saturation scene, colors of streamers may be varied to render the cross light more readily recognizable; and in a high-key image, fewer cross light with shorter streamers may be provided, and/or the shapes of cross light may be varied. These are examples of conditions that may be added to the processing conditions for special processing 1 to 3. When an image is found to have no matching scene in the scene identification, processing may be performed only according to the conditions that are determined automatically based on face region information.

The scene-specific processing conditions apply to other areas than face regions.

Thus obtained is an image having undergone special processing resulting in natural appearances even in other areas of an image than face regions, such as an area representing a landscape.

Thus, in the above method, a type of processing that should preferably not be applied to a face region is not performed in the face region or, alternatively, is performed with a reduced intensity in the face region, whereby special processing that yields an image with natural appearances is performed. Further, the special processing also produces sufficient effects on an image of a landscape by setting area-specific processing conditions such that natural appearances may result from the processing.

The special processing means 20 thus modifies the conditions for special processing applied to corrected image data, performs special processing as required by the corrected image data according to the modified conditions, and sends thus processed data to the image output means 22. The image output means 22 outputs the supplied output image data by the method described above.

As is apparent from the foregoing description, the image processing apparatus 11 according to the present invention is capable of performing different types of special processing in different areas such that the presence of human face or faces in an image is automatically detected and, optionally, a scene identification is executed and, according to the results obtained in these steps, target areas to which various types of special processing are applied and intensities with which various types of special processing are performed are determined automatically. Thus, the possibility of performing a type of processing in a particular area to which that processing should preferably not be applied can be eliminated, yielding an image with natural appearances that do not convey strange feelings. Further, processing is automatically performed, which avoids the burdens customers and an operator would otherwise have.

While, in the first embodiment of the invention, the settings of processing conditions are all performed automatically in the special processing means 20, there may be cases, for example, where a customer desires to have higher soft focusing effect in an image that contains only a landscape. Therefore, the special processing means 20 may have two processing modes: an automatic processing mode and a manual processing mode. Thus, the processing may be switched between the two modes to allow manual settings of processing conditions when desired.

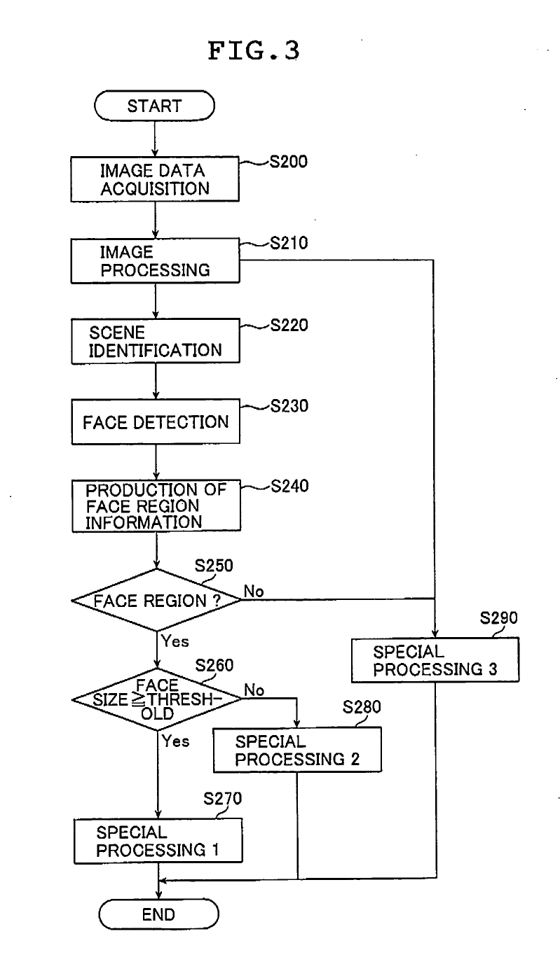

Now a second embodiment of the present invention will be described in detail referring to the flow chart illustrated in FIG. 3.

In the first embodiment described above, face detection is executed, and preferably, scene identification is executed to modify the processing conditions for special processing according to the results of the face detection and, optionally, the results of the scene identification. In the second embodiment, scene identification is executed, and preferably, face detection is executed to modify the processing conditions for special processing according to the results of the scene identification and, optionally, the results of the face detection.

According to the second embodiment, it should be understood that, when the face detection is executed, the results thereof may also be used, where necessary, to set conditions for ordinary image processing other than for special processing. Thus, the second embodiment may also be used in the image forming apparatus 10 illustrated in FIG. 1, and the explanation will therefore be made below by referring to the image forming apparatus 10 of FIG. 1. Note that the face detecting means 14 is not an essential component of the second embodiment.

On acquiring image data as in S100 of FIG. 2, the image data acquiring means 12 sends the image data to the image processing means 16 and the face detecting means 14 (S200). As in the first embodiment, the corrected image data may be thinned out before supplying to the face detecting means 14, because the face detecting means 14 only requires image data necessary for face detection.

The image processing means 16 performs image processing on supplied image data as in S130 of FIG. 2 to produce corrected image data (S210). Then, the image processing means 16 sends fully corrected image data to the special processing means 20 while sending such corrected image data that requires special processing to the scene identifying means 18. The scene identifying means 18 only requires image data necessary for scene identification, so data obtained by thinning out corrected image data may be supplied to the scene identifying means 18.

As in S140 of FIG. 2, the scene identifying means 18 analyzes corrected image data,supplied, and identifies the image data as corresponding to any of an evening view scene, a night view scene, an undersea scene, a blue-sky scene, a high-saturation scene, a high-key scene and other scenes, to thereby produce scene information (S220). The scene identifying means 18 sends the scene information to the special processing means 20.

When all of corrected image data and scene information become available, the special processing means 20 determines whether corrected image data supplied requires special processing or not as in the first embodiment. Then the special processing means 20 sends the image data not requiring special processing to the image output means 22 without performing any processing. When image data is found to require special processing, the special processing means 20 sets processing conditions for special processing according to the scene information supplied from the scene identifying means 18.

Scene-specific processing conditions may be adjusted as in the first embodiment. Cross filtering processing, for example, may be modified as follows: in an evening view scene, relatively large cross light with relatively long streamers may be provided in an evening view area; in a night view scene, relatively many cross light and/or cross light with relatively long streamers may be provided to adjust, for example, the intensity of the processing. Such conditions are added to the processing conditions for special processing. When an image is found to have no matching scene in the scene identification, conditions for special processing may be set according to preset standard conditions.

A landscape area or the like is subjected to special processing appropriate to scene information to yield an image with natural appearances.

Meanwhile, the face detecting means 14 executes face detection (S230) as in 5110 of FIG. 2 on the image data supplied from the image data acquiring means 12 to produce face region information (S240) based on the results of the face detection as in S120, and sends the face region information to the special processing means 20. The special processing means 20 modifies the conditions for special processing according to the face region information it receives.

Processing conditions are determined by judging whether corrected image data contains a face from the face region information based on the results of the face detection (S250) as in S150 of FIG. 2. When an image is found to contain a face, the special processing means 20 compares a predefined threshold of a face region and the area of the face region contained in the face region information, and determines whether the area of the face region in corrected image data is equal to or larger than the threshold, or smaller than the threshold (S260) as in S160 of FIG. 2. Thus, corrected image data are sorted automatically into three categories and different processing conditions are determined for different categories of sorted data. Such sorting based on a threshold may be executed by comparing the area of each face region with a threshold as in the first embodiment. The position of a face or the face detection reliability may also be taken into consideration in the sorting process as in the first embodiment.

When a face region is detected in S250 and the area of the face region is found to be equal to or larger than the threshold in S260, the special processing means 20 modifies the processing conditions for the special processing according to the conditions for the special processing 1 (S270) as in S170 of FIG. 2. As in the first embodiment, the processing conditions for the special processing 1 apply to images that contain a face region having an area equal to or larger than a threshold.

When a face region is detected in S250 and the area of the face region is found to be smaller than the threshold in S260, the special processing means 20 modifies the processing conditions for the special processing according to the processing conditions for the special processing 2 (S280) as in S180 of FIG. 2. As in the first embodiment, the processing conditions for the special processing 2 apply to an image that contains a face region having an area smaller than a threshold.

When no face region is detected in S250, the special processing means 20 modifies the processing conditions for the special processing according to the processing conditions for the special processing 3 (S290) as in S190 of FIG. 2. As in the first embodiment, the processing conditions for the special processing 3 apply to an image without faces, such as a scenery image.

The special processing means 20 thus modifies the conditions for special processing to be performed on corrected image data according to the results of the scene identification and, optionally, the results of the face detection, performs required special processing on the corrected image data according to the modified conditions, and sends thus processed data to the image output means 22. The image output means 22 outputs the supplied output image data by the method described above.

As is apparent from the foregoing description, the image processing apparatus 11 according to the present invention is capable of special processing appropriate to a scene by automatically determining, for example, the intensities of various special processing operations based on the results of the scene identification. Thus, processing can be performed to yield an image with natural appearances that do not convey strange feelings. Further, processing is automatically performed, which avoids the burdens customers and an operator would otherwise have.

Furthermore, two modes of processing may be provided, i.e., an automatic processing mode and a manual processing mode, such that the processing may be switched between the two modes to allow manual settings of processing conditions where desired.

While the image processing method, the image processing program, and the image processing apparatus according to the present invention have been described above in detail, the present invention is not limited to the above embodiments and that various improvements and modifications may be made without departing from the spirit and scope of the invention.

For example, while, in the embodiment represented in FIG. 2, images are sorted into three categories according to the area of face regions to modify the conditions for special processing, images may be sorted into two categories depending on whether or not an image contains a face/faces to modify the conditions for special processing. Alternatively, images may be sorted into four or more categories according to the area of the face regions to modify the processing conditions for special processing.

Further, the present invention is not only applicable to still images but also to one-frame images from a motion picture such that the processing is performed on successive frames of the motion picture in the same manner as the processing applied to still images.

Furthermore, the processing conditions for special processing may be modified according to the face detection reliability. When soft focusing processing is performed, for example, the amounts by which image processing conditions are modified and/or the intensities with which image processing is performed may be adjusted according to the face detection reliability such that the intensity of soft focusing processing, for example, may be reduced when the face detection reliability is low.

What is claimed is:

1. An image processing apparatus for performing image processing on acquired image data, comprising:
face detecting means for detecting a face from an image represented by said acquired image data;
common processing means for automatically performing predetermined common image processing on said image data; and
special processing means for performing special processing on said image data based on processing conditions for said special processing, said special processing being different from said predetermined common image processing and being image processing to be executed in accordance with designation from an external; wherein
said face detecting means supplies a result of face detection obtained by said face detecting means to said special processing means, and
said special processing means modifies said processing conditions for said special processing to be performed in accordance with said result of said face detection supplied by said face detecting means.

2. The image processing apparatus according to claim 1, wherein said face detecting means supplies to said special processing means as said result of said face detection, information that indicates at least one of distinction between presence and absence of said face, a position of said face and a size of said face.

3. The image processing apparatus according to claim 2, wherein
said face detecting means supplies to said special processing means as said result of said face detection, the information that indicates at least said distinction between presence and absence of said face and said size of said face, and,
when said special processing means performs soft focusing processing for providing a soft focus effect as said special processing, said special processing means modifies an intensity of said soft focusing processing in accordance with said supplied information that indicates said distinction between presence and absence of said face and said size of said face.

4. The image processing apparatus according to claim 2, wherein
said face detecting means supplies to said special processing means as said result of said face detection, the information that indicates at least said distinction between presence and absence of said face and said position of said face, and,
when said special processing means performs cross filtering processing for providing a cross filter effect as said special processing, said special processing means sets conditions for said cross filtering processing in accordance with said supplied information that indicates at least said distinction between presence and absence of said face and said position of said face such that cross light obtained by said cross filtering processing and a face region of said face do not overlap each other.

5. The image processing apparatus according to claim 2, wherein
said face detecting means supplies to said special processing means as said result of said face detection, the information that indicates at least said distinction between presence and absence of said face and said position of said face, and,
when said special processing means performs image composition processing as said special processing, said special processing means sets conditions for said image composition in accordance with said supplied information that indicates at least said distinction between presence and absence of said face and said position of said face such that an image to be superimposed and a face region of said face do not overlap each other.

6. The image processing apparatus according to claim 2, wherein
said face detecting means supplies to said special processing means as said result of said face detection, the information that indicates at least said distinction between presence and absence of said face and said position of said face, and,
when said special processing means performs lighting processing for providing a lighting effect as said special processing, said special processing means modifies an intensity of said lighting processing in a face region of said face in accordance with said supplied information that indicates said distinction between presence and absence of said face and said position of said face.

7. The image processing apparatus according to claim 1, further comprising:
scene identifying means for executing scene identification of said image and supplying a result of said scene identification to said special processing means, wherein
said special processing means modifies said processing conditions for said special processing to be performed in accordance with said result of said scene identification supplied by said scene identifying means in addition to said result of said face detection supplied by said face detecting means.

8. An image processing apparatus for performing image processing on acquired image data, comprising:
scene identifying means for executing scene identification of an image represented by said acquired image data;
common processing means for automatically performing predetermined common image processing on said image data: and
special processing means for performing special processing on said image data based on processing conditions for said special processing, said special processing being different from said predetermined common image processing and being image processing to be executed in accordance with designation from an external; wherein
said scene identifying means supplies a result of said scene identification obtained by said scene identifying means to said special processing means, and
said special processing means modifies said processing conditions for said special processing to be performed in accordance with said result of said scene identification supplied by said scene identifying means.

9. The image processing apparatus according to claim 8, wherein,
when said special processing means performs cross filtering processing for providing a cross filter effect as said special processing, said special processing means modifies at least one of an intensity of said cross filtering processing, a shape of cross light obtained by said cross filtering processing and a color of said cross light in accordance with said result of said scene identification.

10. The image processing apparatus according to claim 8, wherein,
when said special processing means performs lighting processing for providing a lighting effect as said special processing, said special processing means modifies an intensity of said lighting processing in accordance with said result of said scene identification.

11. The image processing apparatus according to claim 8, further comprising:
face detecting means for detecting a face from said image represented by said image data and supplying a result of face detection to said special processing means, wherein
said special processing means modifies said processing conditions for said special processing to be performed in accordance with said result of said face detection supplied by said face detecting means in addition to said result of said scene identification supplied by said scene identifying means.

12. An image processing method for performing image processing on acquired image data, comprising the steps of:
detecting a face from an image represented by said acquired image data and/or executing scene identification of said image;
modifying processing conditions for special processing to be performed in accordance with results of face detection and/or said scene identification;
automatically performing predetermined common image processing on said image data; and
performing said special processing on said image data based on said modified processing conditions for said special processing,
wherein said special processing is different from said predetermined common image processing and image processing to be executed in accordance with designation from an external.

13. An image processing program to execute on a computer an image processing method for performing image processing on acquired image data, said image processing method, comprising the steps of:
detecting a face from an image represented by said acquired image data and/or executing scene identification of said image;
modifying processing conditions for special processing to be performed in accordance with results of face detection and/or said scene identification;
automatically performing predetermined common image processing on said image data; and
performing said special processing on said image data based on said modified processing conditions for said special processing,
wherein said special processing is different from said predetermined common image processing and image processing to be executed in accordance with designation from an external.
